(19) United States
(12) Patent Application Publication
(10) Pub. No.: US 2025/0118865 A1
(43) Pub. Date: Apr. 10, 2025

(54) SKIN-LAYERED POROUS SEPARATORS AND RELATED METHODS

(71) Applicants: Lawrence Livermore National Security, LLC, Livermore, CA (US); THE BOARD OF TRUSTEES OF THE UNIVERSITY OF ILLINOIS, Urbana, IL (US); THE REGENTS OF THE UNIVERSITY OF CALIFORNIA, Oakland, CA (US)

(72) Inventors: Juergen Biener, San Leandro, CA (US); Sijia Huang, Dublin, CA (US); Longsheng Feng, Dublin, CA (US); Jianchao Ye, Tracy, CA (US); Meghann Christine Ma, San Diego, CA (US); Donglin Li, Chicago, IL (US); Kun Wang, Chicago, IL (US); Sangil Kim, Wilmette, IL (US); Jiandi Wan, Davis, CA (US)

(21) Appl. No.: 18/376,778

(22) Filed: Oct. 4, 2023

(51) Int. Cl. H01M 50/491; H01M 10/0525; H01M 50/403; H01M 50/414; H01M 50/449

(52) U.S. Cl. CPC H01M 50/491; H01M 10/0525; H01M 50/403; H01M 50/414; H01M 50/449

(57) ABSTRACT

A product, in accordance with one aspect of the present invention, includes a porous first layer having a first porosity, and a porous skin layer having a second porosity that is relatively lower than the first porosity. The skin layer is a self-formed layer. A method, in accordance with one aspect of the present invention, includes contacting a resin with a separator. The resin is exposed to radiation for curing the resin, thereby simultaneously creating a porous first layer and a porous skin layer positioned between the first layer and the separator. The first layer has a first porosity. The skin layer has a second porosity that is relatively lower than the first porosity.

This invention was made with Government support under Contract No. DE-AC52-07NA27344 awarded by the United States Department of Energy. The Government has certain rights in the invention.

### FIELD OF THE INVENTION

The present invention relates to porous separators, and more particularly, this invention relates to skin-layered porous separators useful for devices such as secondary batteries, as well as for methods such as separation processes including separation and purification of rare earth materials, and for medical applications such as dialysis membranes.

### BACKGROUND

Secondary lithium ion (Li-ion) batteries are a rechargeable electrochemical energy storage device typically used in high powered applications including portable electronics, vehicles, and grid energy storage. A typical Li-ion battery has a porous separator sandwiched between a positive and a negative electrode. The components are wetted with electrolyte to be ionically conductive but electrically insulating. In particular, the separator functions as a physical barrier to prevent electrical short circuiting (i.e., contact between positive and negative electrode or lithium dendrite penetration) but also acts as a conduit for Li-ions to shuttle back and forth during electrochemical (charging-discharging) cycling.

However, there are generally tradeoffs between safety, mechanical stability, cycling stability, and performance (e.g., ion conductivity) in separators. High performance such as high power and high energy density promote Li dendrite growth and penetration through the separator, which leads to a dead cell or a potentially explosive cell due to short circuit and thermal runaway.

An ideal separator is one that can allow rapid Li-ion transport while effectively inhibiting or preventing the passage of other harmful or detrimental species/structures such as anions and Li dendrites. For that, microstructure and architecture design are critical. For Li-ion batteries, the Li-ion transport in organic liquid electrolytes is usually not the rate-limiting step because of the high conductivity on the order of 1-10 mS/cm. The effective conductivity of the separator infilled with liquid electrolytes is reduced by an order of magnitude due to the tortuosity of the porous separator architecture and the relatively low porosity of commercial separators. When the operation temperature drops to −20° C. or below, as is typical in some geographic locations in the winter season, the conductivity drops to well below 0.1 mS/cm, which drastically affect the available power.

Therefore, it is critical to further optimize the porous separator structure to increase the ionic conductivity. Increasing the porosity of the separator helps, but it reduces the mechanical modulus and strength, which tends to reduce the effectiveness in blocking Li dendrites.

To suppress Li dendrite growth and penetration, past proposed solutions include the use of low porosity or thick separators, which however increases internal resistance. Celgard separators with PP/PE/PP porous trilayers have been the industrial standard for coin cells, cylindrical cells and pouch cells. However, the porosity of about 39% is low for high-rate performance and the thermoplastic properties (e.g., melt and shrink during thermal runaway) can worsen the battery safety problem.

Many of the proposed mitigation methods for the dendrite penetration and polysulfide anions shuttling problems are based on the modification of the commercial Celgard separators. Atomic layer deposition (ALD) coatings and multilayer composite structures have shown promising results in improving the mechanical strength and achieving good permselectivity and/or transference number. However, such structures are difficult to fabricate, and have yet to achieve high-rate performance.

### SUMMARY

A product, in accordance with one aspect of the present invention, includes a porous first layer having a first porosity, and a porous skin layer having a second porosity that is relatively lower than the first porosity. The skin layer is a self-formed layer.

A method, in accordance with one aspect of the present invention, includes contacting a resin with a separator. The resin is exposed to radiation for curing the resin, thereby simultaneously creating a porous first layer and a porous skin layer positioned between the first layer and the separator. The first layer has a first porosity. The skin layer has a second porosity that is relatively lower than the first porosity.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a partial cross sectional view of a product having a first and skin layer, in accordance with one aspect of the present invention.

FIG. 2 is a partial cross sectional representational view of a product for a battery application, in accordance with one aspect of the present invention.

FIG. 3 is a partial cross sectional representational view of a product having laminates of first and skin layers, in accordance with one aspect of the present invention.

FIG. 4 is a partial cross sectional representational view of a product having laminates of first and skin layers, in accordance with one aspect of the present invention.

FIG. 5 is a partial cross sectional view of a product having yet another type of laminate configuration, in accordance with one aspect of the present invention.

FIG. 6 is a partial cross sectional representational view of a product, in accordance with one aspect of the present invention.

FIG. 7 includes partial cross sectional representational views of exemplary cross-sectional shapes of three-dimensional features, in accordance with various aspects of the present invention.

FIG. 8 is a flow diagram of a method, in accordance with one aspect of the present invention.

FIG. 9 is a representational view of a method, in accordance with one aspect of the present invention.

FIG. 10 depicts an apparatus for forming a product, in accordance with one aspect of the present invention.

FIG. 11 depicts scanning electron microscope (SEM) images of a structure formed using the process of FIG. 8.

FIG. 12 includes cross-sectional images of skin and first layers formed with and without porogens, in accordance with various aspects of the present invention.

FIG. 13 is a chart depicting the ratio of the denser skin layer to the first layer for each of the samples in FIG. 12.

FIG. 14 includes SEM images illustrating the effect of use of different separators on porosity, in accordance with various aspects of the present invention.

FIG. 15 includes various side representational views of a product having multiple layers, in accordance with one aspect of the present invention.

FIG. 16 is a side representational view of a product having a bilayer structure, in accordance with one aspect of the present invention.

FIG. 17 is a chart illustrating the results of an experiment comparing a commercially available separator with a separator created according to the teachings herein.

FIG. 18 is an SEM image of a trilayer structure, in accordance with one aspect of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of skin-layered porous separators and/or related products and methods. The skin-layered porous separators disclosed herein are particularly useful for lithium secondary batteries such as Li-ion batteries, Li—S batteries, etc. Also disclosed herein is a general method for fabrication of 3D printed, single and multistacked skin-layered microporous separators for blocking Li dendrite penetration and Li polysulfide anions shuttling. The relatively higher porosity in the microporous layer allows fast Li-ion transport, while the thin dense skin layer blocks Li metal dendrite penetration and the polysulfides crossover. In various aspects, the inventive skin-layered microporous separator prevents electric shorting and improves the cycling stability of high-power Li-ion batteries, high energy density lithium metal batteries and low-cost lithium sulfur batteries.

A product, in accordance with one aspect of the present invention, includes a porous first layer having a first porosity, and a porous skin layer having a second porosity that is relatively lower than the first porosity. The skin layer is a self-formed layer.

A method, in accordance with one aspect of the present invention, includes contacting a resin with a separator. The resin is exposed to radiation for curing the resin, thereby simultaneously creating a porous first layer and a porous skin layer positioned between the first layer and the separator. The first layer has a first porosity. The skin layer has a second porosity that is relatively lower than the first porosity.

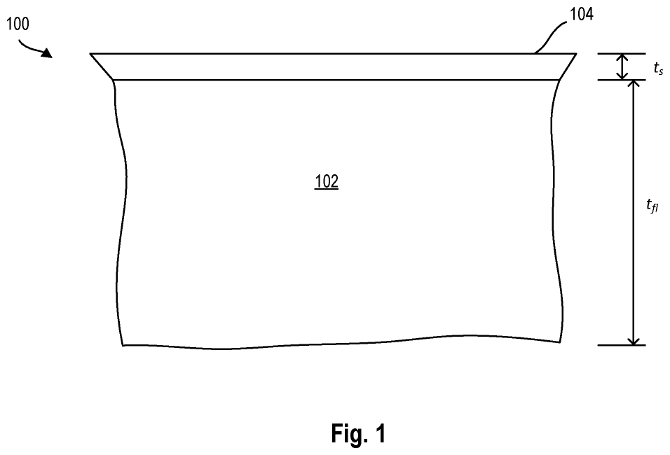

FIG. 1 depicts a product 100, in accordance with one embodiment. As an option, the present product 100 may be implemented in conjunction with features from any other embodiment listed herein, such as those described with reference to the other FIGS. Of course, however, such product 100 and others presented herein may be used in various applications and/or in permutations which may or may not be specifically described in the illustrative embodiments listed herein. Further, the product 100 presented herein may be used in any desired environment.

As shown, the product includes a porous first layer 102 having a first porosity, and a porous skin layer 104 having a second porosity that is relatively lower than the first porosity. The skin layer 104 is a self-formed layer created simultaneously with the first layer 102.

The first and skin layers 102, 104 have physical characteristics of simultaneous formation with each other via curing, such as radiation (e.g., ultraviolet (UV) light) curing. More details about curing is provided below in the discussion of exemplary methods of fabrication. In preferred approaches, the layers 102, 104 form together during a single exposure step.

In some approaches, a thickness tₛ of the skin layer 104 measured perpendicular to its plane of formation is less than about one quarter of a thickness t_{fl} of the first layer 102. In preferred approaches, the thickness tₛ of the skin layer 104 is less than about one tenth of the thickness t_{fl} of the first layer 102.

In one approach, the thickness t_{fl} of the first layer 102 is in a range of about 5 micrometers (μm) to about 20 μm, and the thickness tₛ of the skin layer 104 is in a range of about 50 nanometers (nm) to about 500 nm. For battery applications, the thinness of the skin layer 104 results in little impedance to passage of Li-ions therethrough.

In some approaches, the first porosity of the first layer 102 is in a range of about 40% to about 90% by volume of the total peripheral volume of the first layer 102, i.e., the volume within an imaginary boundary extending along the periphery of the first layer 102. The second porosity of the skin layer 104 is less than the first porosity. In some approaches, the second porosity is less than about 80% of the first porosity per unit volume, preferably less than about 60% of the first porosity. Preferably, the second porosity is greater than about 20% of the first porosity per unit volume.

In some aspects, the average pore size of the skin layer 104 is less than about 10% of the average pore size of the first layer 102. Preferably, the average pore size of the skin layer 104 is about 95-99.7% smaller than the average pore size of the first layer 102 for Li-ion battery applications. In one example, in which an average pore size in the first layer is in a range of 75-300 nm, the average pore size in the skin layer 104 is several nm (e.g., 0.5-5 nm), and preferably toward the lower end of this range (e.g., less than about 1 nm), to essentially prevent polysulfide anion transfer. Note that the average pore sizes can be modified to be higher or lower in either layer in other applications, e.g., battery and non-battery applications.

The average pore sizes of the first and skin layers 102, 104 are preferably in a range required for the intended application, e.g., to allow passage of a desired component such as Li-ions therethrough. In some approaches, the average pore size of the skin layer 104 is less than about 10 nm, ideally suited for Li-ion batteries. For Li—S batteries, an average pore size of about 1 nm or less is preferred. This allows for the passage of Li ions while blocking larger unwanted ions such as polysulfides, which typically have a diameter of greater than about 0.8 nm. Note, however, that the average pore size could be higher than these ranges, depending on the intended use. In some approaches, the average pore size of the first layer 102 is in the 10s of nanometers to the 100s of nanometers, but could be higher or lower depending on the intended use.

Note that in most approaches, the pores of the layers 102, 104 are interconnected to provide continuous paths between opposite outer surfaces of the first and skin layers, e.g., to allow passage of a desired component such as Li-ions therethrough.

The average pore sizes of the first and skin layers 102, 104 may be selected via material selection and/or processing parameters, as described in more detail below.

The average pore sizes of the first and skin layers 102, 104 may be predefined by selection of a porogen. Accordingly, the pores of the first and skin layers 102, 104 may, in some aspects, have physical characteristics of a previously-present porogen that has been removed from the respective layer. Illustrative physical characteristics of a previously-present porogen include pores having a shape corresponding to solid porogens, e.g., generally spherical pores having inner surfaces corresponding to the outer surfaces of generally spherical porogens; pores having a shape corresponding to fluid porogens, e.g., inner surfaces corresponding to drops/channels of a liquid, gaseous bubbles, etc.; pores emerged from phase separation of the monomer/solvent mixture during polymerization of the monomer component in which case the pore morphology is determined by the rate and driving force of the phase separation process; etc.

More details about exemplary porogens are provided below in the description of the methods of manufacture.

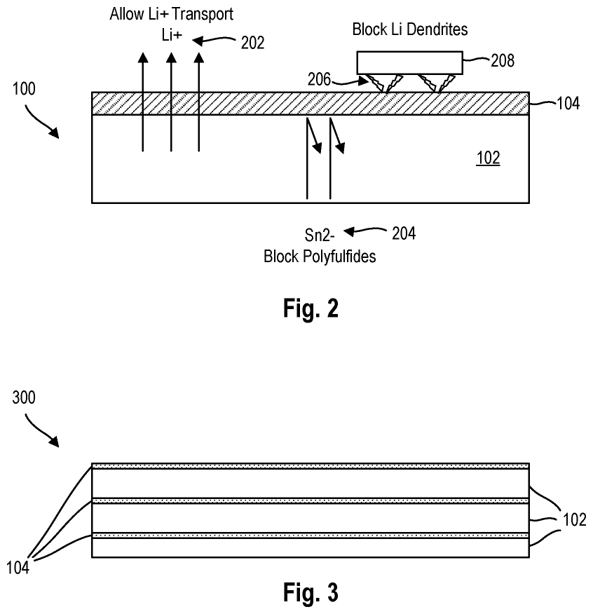

FIG. 2 depicts an aspect of the product 100 which is particularly useful as a separator for battery applications, in accordance with one embodiment. As an option, the present product 100 may be implemented in conjunction with features from any other embodiment listed herein, such as those described with reference to the other FIGS. Of course, however, such product 100 and others presented herein may be used in various applications and/or in permutations which may or may not be specifically described in the illustrative embodiments listed herein. Further, the product 100 presented herein may be used in any desired environment.

As shown in FIG. 2, in the illustrated battery application, the first layer 102 provides mechanical stability and high ionic conductivity, especially for Li secondary batteries. The first porosity is preferably selected, e.g., via choice of porogen, extent and kinetics of crosslinking, etc. to provide high Li-ion conductivity to reduce polarization under fast charging conditions.

Also preferably, the dense skin layer 104 in this approach, is configured to provide high selectivity yet high permeance for Li-ion 202 transport while substantially blocking passage of polysulfide anions 204 through the skin layer 104 via size exclusion and/or electrochemical mechanisms (e.g., via charge, functional groups, etc.).

Ideally, the skin layer 104 is effective to allow no more than 5% of polysulfide anions (e.g., S4²⁻, S6²⁻, S8²⁻) present in the target application (e.g., use in/as a battery) ever pass through the skin layer 104 during the manufacturer-specified service life of the product. The charging properties of the polymer assist in rejecting polysulfide anions. Typically, polysulfide anions are generated from the cathode side, and if they make their way to the anode, solids form, such as lithium sulfide, which reduces power capacity of battery. Moreover, the high resistivity of lithium sulfide reduces the kinetics of the battery.

Also preferably, the skin layer 104 possesses high modulus and low porosity sufficient to prevent lithium metal dendrite penetration, which is passage of lithium dendrites 206 through the skin layer 104 primarily from the anode 208. Ideally, all types of dendrites are blocked, including crystalline dendrites, mossy dendrites, and plated dendrites. For example, preferred embodiments have skin layers that are able to resist puncture from the dendrites. Moreover, by blocking dendrite penetration into the separator product 100, pore blockage due to dendrite growth is reduced, thereby maintaining the channels open for Li-ion transport across the separator.

FIG. 3 depicts a product 300 having laminates of first and skin layers 102, 104, in accordance with one embodiment. As an option, the present product 300 may be implemented in conjunction with features from any other embodiment listed herein, such as those described with reference to the other FIGS. Of course, however, such product 300 and others presented herein may be used in various applications and/or in permutations which may or may not be specifically described in the illustrative embodiments listed herein. Further, the product 300 presented herein may be used in any desired environment.

As shown in FIG. 3, three sets of porous first and skin layers 102, 104 are formed one atop the other in a laminate. More or fewer sets of the layers 102, 104 may be present in various approaches, e.g., two sets, four sets, five sets, ten sets, and so on. The first layers 102 in the various sets may be essentially the same as one another, or different, e.g., in terms of composition, porosity, properties, etc. Likewise, the skin layers 104 in the various sets may be essentially the same as one another, or different, e.g., in terms of composition, porosity, properties, etc. Preferably, the porosities of the various layers extends throughout the laminate in continuous paths to allow transport of target elements, such as Li-ions, completely through the laminate from one side to the other.

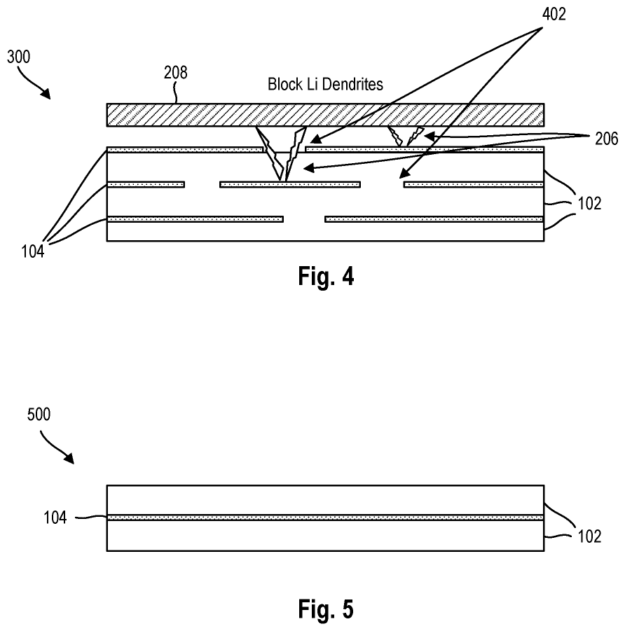

Referring to FIG. 4, a multilayer laminate of first and skin layers 102, 104 may reduce the change of defect-induced failure. Particularly, if there are defects 402, e.g., gaps, in the skin layers 104, the defects 402 in the different skin layers 104 are unlikely to line up vertically, thereby blocking dendrite 206 penetration completely through the laminate, as shown.

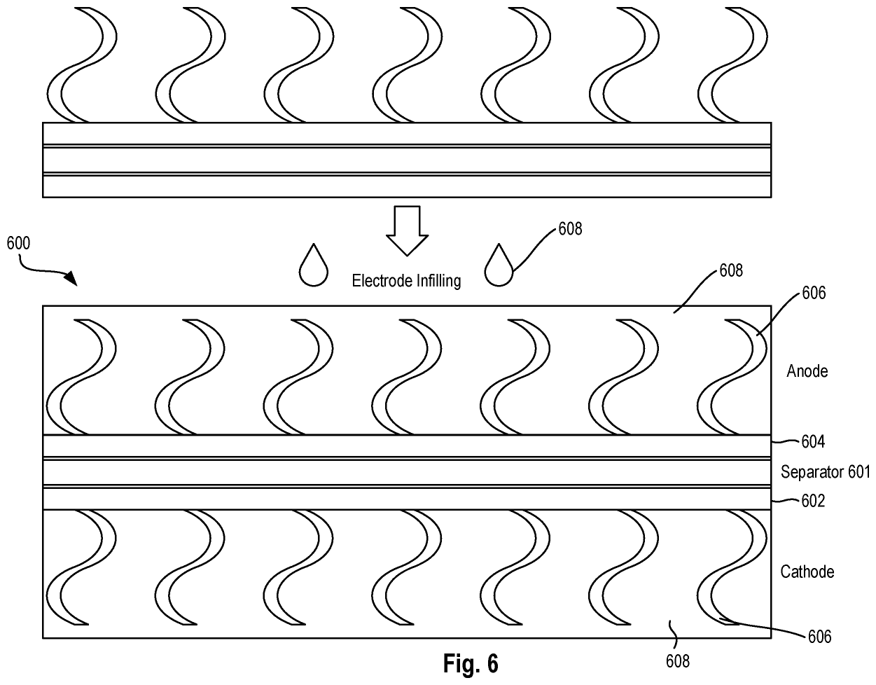

FIG. 5 depicts a product 500 having yet another type of laminate configuration, in accordance with one embodiment. As an option, the present product 500 may be implemented in conjunction with features from any other embodiment listed herein, such as those described with reference to the other FIGS. Of course, however, such product 500 and others presented herein may be used in various applications and/or in permutations which may or may not be specifically described in the illustrative embodiments listed herein. Further, the product 500 presented herein may be used in any desired environment.

As shown, the product has first layers 102 sandwiching a skin layer 104, whereby the upper first layer 102 does not have a skin layer formed thereabove.

A variation of the product 500 may include multiple laminates of first and skin layers, with the first layers being the outer layers.

Moreover, one or more additional layers of conventional type may be added to any of the structures having first and skin layers as described herein. Such additional layers may be porous or nonporous.

FIG. 6 depicts a product 600, in accordance with one embodiment. As an option, the present product 600 may be implemented in conjunction with features from any other embodiment listed herein, such as those described with reference to the other FIGS. Of course, however, such product 600 and others presented herein may be used in various applications and/or in permutations that may or may not be specifically described in the illustrative embodiments listed herein. Further, the product 600 presented herein may be used in any desired environment.

As shown, the product 600 includes a cathode 602 and an anode 604 on opposite sides of a separator 601 having at least one first layer and at least one skin layer (e.g., the bilayer structure of product 100 of FIG. 1 or laminate structures as in other FIGURES). While the cathode 602 and/or anode 604 are planar in some approaches, the cathode 602 and/or anode 604 may have three-dimensional features 606 extending away from the separator 601 in a direction about perpendicular to a plane of the layers of the product 100. The three-dimensional features 606 may have any desired shape. Electrolyte 608 is infilled around the three-dimensional features 606.

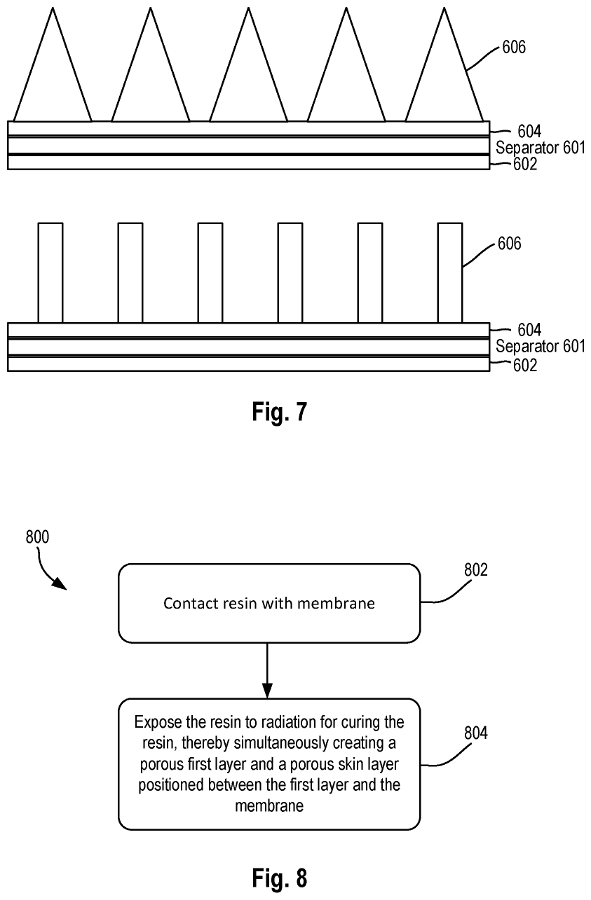

In the approach shown in FIG. 6, both the cathode 602 and anode 604 have three-dimensional features 606. In this example, the features 606 are wavy, having S-shaped cross-sectional shapes. FIG. 7 depicts other exemplary cross-sectional shapes of three-dimensional features 606, including rectangular and pyramidal cross-sectional designs.

In some approaches, the bilayer structure or multilayer structure may be printed together with three dimensional architectures, to allow the 3D integration with cathode 602 and anode 604. For example, creating elongated pillars, lands, pyramids, wavy structures, etc. may facilitate Li-ion transport in thick electrodes, which benefits high power and energy density cell designs.

Thus, in any of the aspects described herein, the formed separator having at least one first layer and at least one skin layer can be used with conventional liquid electrolytes to replace conventional separators for Li-ion batteries and lithium sulfur batteries. Such separators may also be used as a robust scaffold for the infilling of solid polymer electrolytes to ensure the safety and performance of next-generation solid state lithium metal batteries.

The separators described herein may also be used for other applications where high permeance and/or high selectivity are beneficial, such as CO₂ separation, hemodialysis, fuel cell, etc.

FIG. 8 depicts a method 800, in accordance with one embodiment. As an option, the present method 800 may be implemented to construct structures such as those shown in the other FIGS. described herein. Of course, however, this method 800 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 8 may be included in method 800, according to various embodiments. It should also be noted that any of the aforementioned features may be used in any of the embodiments described in accordance with the various methods.

In step 802, a resin is contacted with a separator.

In step 804, the resin is exposed to radiation for curing the resin, thereby simultaneously creating a porous first layer and a porous skin layer positioned between the first layer and the separator. The skin layer is formed with the assistance of the separator.

The first and skin layers may be as described elsewhere herein, e.g., the first layer has a first porosity and the skin layer has a second porosity that is relatively lower than the first porosity.

The resin may include at least one monomer, at least one solvent, and/or at least one porogen. In some approaches, the resin includes a least one monomer, at least one solvent, and at least one porogen. Note that the solvent can also act as porogen (or vice versa) and that, after the resin is cured, the solvent (if acting as porogen), or both the solvent and porogen, are preferably removed via known techniques, e.g., dissolution, etc.

The monomer is preferably present in the resin in at least 10 wt %, which would result in a final first layer having approximately 90 vol % porosity. A preferred range of monomer in the resin at 10-80 wt % based on the total weight of the resin.

Any suitable monomer that would become apparent to one skilled in the art after reading the present disclosure may be used. In one approach, the monomer is a radiation (e.g., UV) curable acrylate monomer (e.g., hexanediol diacrylate (HDDA), polyethylene glycol diacrylate (PEGDA), polyurethane, vinyl acrylate, cyclobutane-1,2,3,4-tetracarboxylic dianhydride (CBDA), etc.). In other approaches, the monomer may be a thiolane.

Any suitable solvent that would become apparent to one skilled in the art after reading the present disclosure may be used. The solvent may be selected via its compatibility with the selected monomer. Exemplary solvents include 1,2-propylene glycol dimethyl ether (PGDME), tetraethylene glycol dimethyl ether (TEGDME), acetonitrile, water, etc. The solvent may be present in the resin at 20-90 wt % based on the total weight of the resin.

Any suitable porogen that would become apparent to one skilled in the art after reading the present disclosure may be used. Some porogens may also be used as solvent if the monomer is sufficiently soluble in the porogen in which case they can replace the solvent. Exemplary porogens include polyethylene glycol (PEG), a low molecular weight liquid that is miscible in and/or dissolves in the solvent, etc. The concentration of porogen in the resin may be selected to provide the desired extent of porosity.

Any suitable membrane that would become apparent to one skilled in the art after reading the present disclosure may be used. The separator is preferably transparent to the radiation used to cure the resin, in approaches where the resin is radiation curable.

Exemplary materials from which the separator may be constructed include one or more of a fluorinated ethylene propylene (FEP) film, glass, silicone, polytetrafluoroethylene (PTFE), (preferably transparent) polypropylene, (preferably transparent) polyethylene, etc. Each of these materials has a particular contact angle and/or particular degrees of wettability with the monomers, solvents, and/or porogens, as well as the formed polymer phase. The interfacial properties govern the formation of the skin layer, and thus characteristics of the skin layer are a function of the contact angle of the separator. For example, a separator having a smaller contact angle with acrylate may attract more acrylate than solvent to the separator, thereby forming a denser skin layer.

The porogen and/or solvent contents (if present) in the resin, as well as printing parameters, determine the density and porosity of the porous layers. Exemplary printing parameters include intensity of radiation, number of exposures, duration of exposures, layer height setting between the stage and the separator, temperature etc. For example, higher radiation intensity and/or longer exposure times tend to increase polymerization, thereby increasing density. Conversely, a lower exposure intensity and/or duration may allow resin to seep into the pores (e.g., during the exposure, during formation of a subsequent layer, etc.), which upon further exposure, results in reduced average pore size (depending on presence and type of porogen). Likewise, formation of additional layers above a skin layer may result in additional radiation exposure of the lower layers, increasing their density.

Any suitable fabrication technique that would become apparent to one skilled in the art after reading the present disclosure may be adapted for use in the method 800. A preferred approach uses projection stereolithography.

As noted above, average pore sizes of the first and skin layers 102, 104 may be selected via material selection and/or processing parameters. For example, use of a HDDA polymer with porogen and solvent (e.g., TEGDME) results in pore sizes of about 20-100 nm. Use of a cyclobutane-1,3-diacid (CBDA) polymer with porogen and solvent (PDME) results in pore sizes of about 5-10 nm. The process can be tuned by use of a chain transferring agent, to render average pore sizes in the hundreds of nm range to the tens of micrometers range.

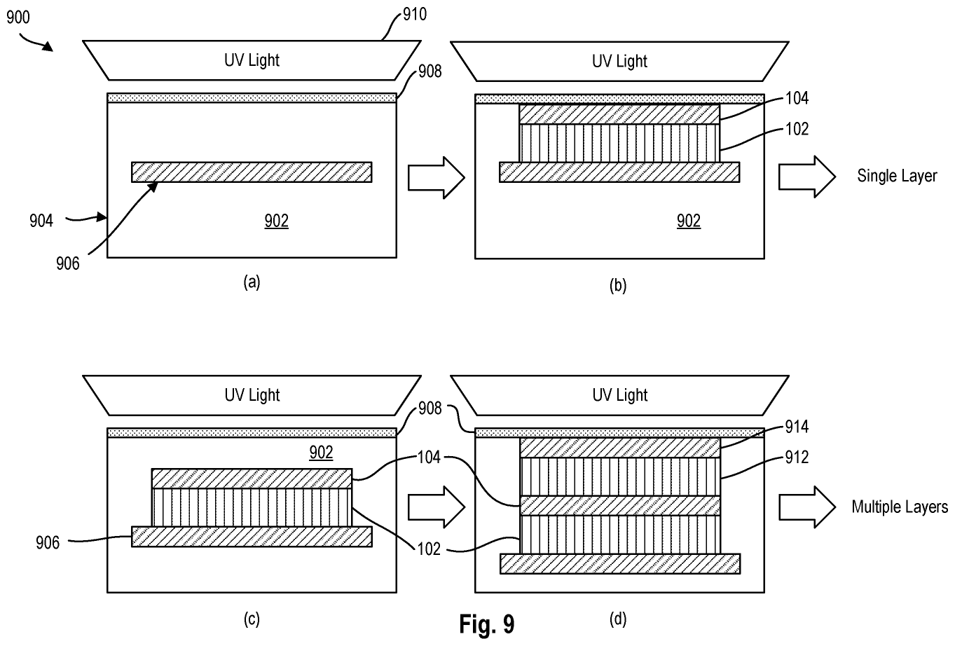

FIG. 9 depicts a method 900, in accordance with one embodiment. As an option, the present method 900 may be implemented to construct structures such as those shown in the other FIGS. described herein. Of course, however, this method 900 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 9 may be included in method 900, according to various embodiments. It should also be noted that any of the aforementioned features may be used in any of the embodiments described in accordance with the various methods.

As shown in part (a) of this exemplary approach, resin 902 is placed in a vat 904. The resin 902 may be of any type described herein. In the embodiment shown, a movable stage 906 is located in the vat 904, though in other approaches, no stage is present. The stage 906 may be formed of metal, glass, an electrically conductive material (which changes the morphology of the porous layer that forms thereon), etc. The separator 908 is placed in contact with the upper surface of the resin 902. The distance between the stage 906 and the separator 908 determines the thickness of the layers formed therebetween. A UV light 910 (or the like) provides radiation to cure the resin 902 located above the stage 906.

Referring to part (b), the UV light 910 exposes the resin, thereby forming a first layer 102 and a skin layer 104.

Parts (a) and (b) depict formation of a single bi-layer.

Referring to part (c), if multiple layers are desired, a relative movement is created between the stage 906 upon which the layers are formed and the separator 908. Unexposed resin 902 is added above the layers 102, 104, where the resin is preferably the same resin, but could be different in some approaches. The unexposed resin is contacted with the separator 908, and the unexposed resin us exposed to radiation for simultaneously creating a porous second layer 912 and a porous second skin layer 914 positioned between the second layer 912 and the separator 908, as shown in part (d). Parts (c) and (d) may be repeated to add more layers, e.g., a porous third layer, a third skin layer, and so on.

Note also that multilayer structures tend to be more mechanically robust than simple bilayers. The same relative thickness as a thick bilayer can be approximated by printing several thinner bilayers.

If porogens are present, the porogens are removed, e.g., via solvent exchange or any other technique that would become apparent to one skilled in the art after reading the present disclosure.

The structure may be dried via supercritical drying to avoid collapse of pores, which could happen if natural drying were performed. In another approach, freeze drying may be used to dry the layers.

In other approaches, the fabrication environment is essentially devoid of moisture, and the solvent exchanged into the structure is compatible with the end use, no drying is performed.

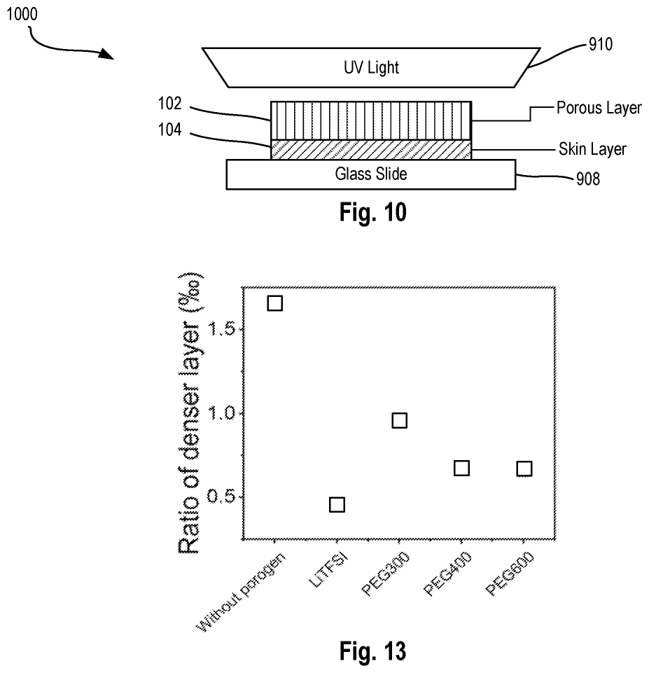

FIG. 10 depicts an apparatus 1000 for forming a product, in accordance with one embodiment. As an option, the present apparatus 1000 may be implemented to construct structures such as those shown in the other FIGS. described herein. Of course, however, this apparatus 1000 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 10 may be included in the methodology enabled by the apparatus 1000, according to various embodiments. It should also be noted that any of the aforementioned features may be used in any of the embodiments described in accordance with the various methods.

As shown, resin is placed above the separator 908. Upon exposure to radiation from the UV light 910, a skin layer 104 and first layer 102 are formed on the separator 908, which in this example is a glass side.

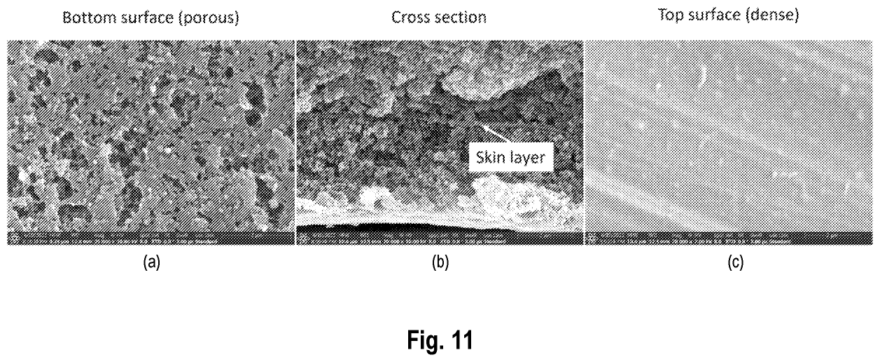

FIG. 11 depicts scanning electron microscope (SEM) images of a structure formed using the process 800 of FIG. 8. Part (a) of FIG. 11 depicts the porous first layer as viewed from the bottom. Part (b) depicts a cross section of the structure, with the skin layer shown in the middle. Part (c) depicts the porous skin layer as viewed from the top.

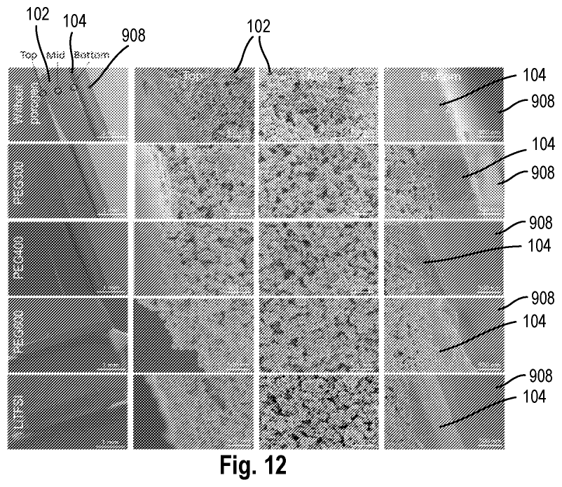

FIG. 12 includes cross-sectional images of skin and first layers 104, 102 formed without porogen in the first row, and in subsequent rows, skin and first layers formed using the denoted porogens. All other formation parameters were the same for each structure. In the resulting structure, the skin layer is formed along the bottom, e.g., according to the method shown in FIG. 10. As shown, the morphology of the layers is a different from sample to sample, depending on the porogen used.

FIG. 13 is a chart depicting the ratio of the denser skin layer to the first layer for each of the samples in FIG. 12. Interestingly, without porogen, the skin layer was much thicker than in the samples prepared with porogens present.

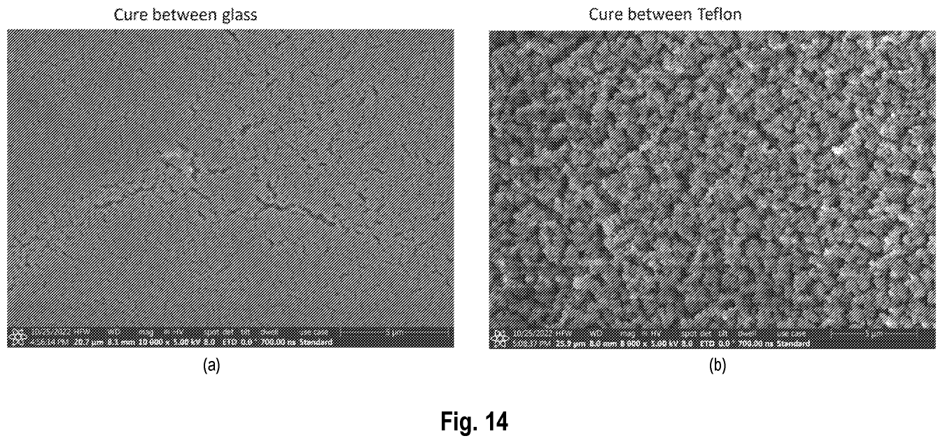

FIG. 14 illustrates the effect of use of different separators on porosity. In part (a), a resin was cured between glass separators. In part (b), the same resin was cured between Teflon separators. The resin in these examples included 37.5 wt % 1,6-hexanediol diacrylate (HDDA), 62.5 wt % PEG400, 0.3 wt % lrg 819 of HDDA. The curing condition was 405 nm light, 14.5 mw/cm² for 30s.

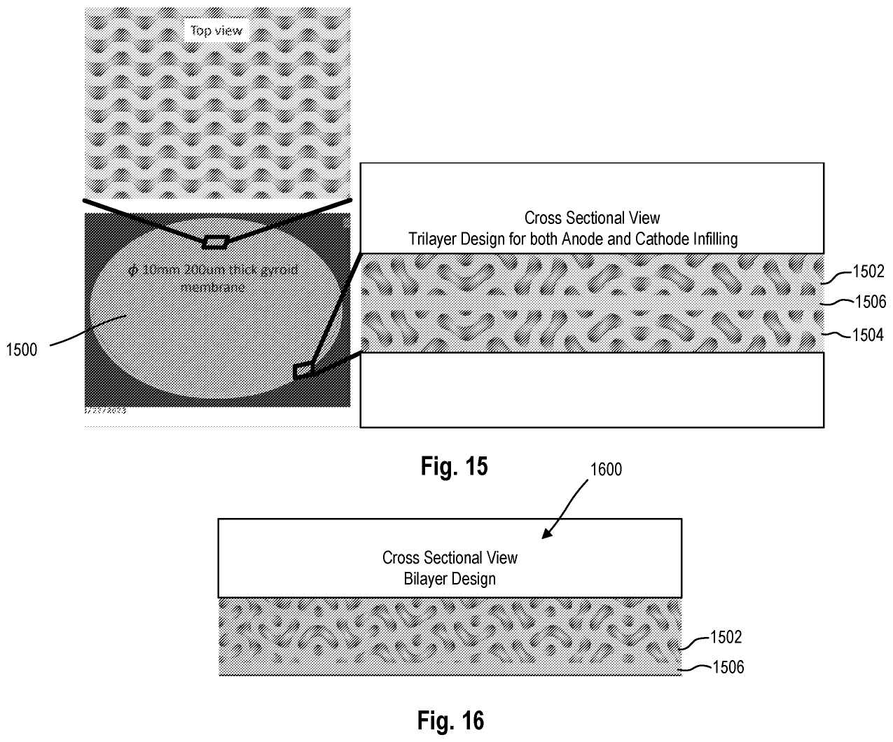

FIG. 15 illustrates more complex structures. As shown, a separator 1500 having a trilayer structure is formed to have a cathode 1502 and anode 1504 with 3D features, as shown in the top and cross sectional views, and a separator 1506 having a skin layer and at least one first layer therebetween. The porous sections may receive a material such as an electrolyte, cathode material, anode material, etc.

FIG. 16 depicts a variation in which a bilayer 1600 is formed. A separator 1506 has a skin layer on the bottom and first layer thereabove.

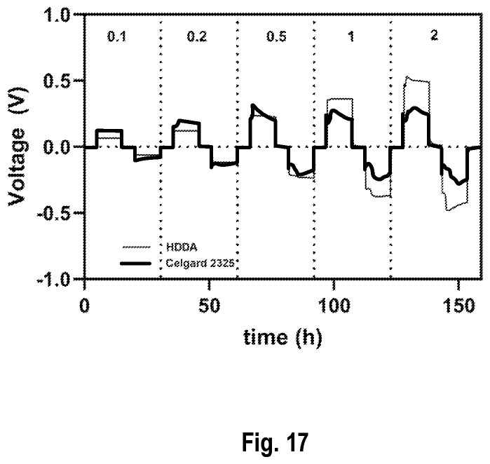

FIG. 17 illustrates the results of an experiment comparing a commercially available separator from Celgard and a separator created according to the teachings herein using a Li metal as the electrodes. Current was cycled at 0.1 mA/cm², then 0.2 mA/cm², 0.5 mA/cm², 1 mA/cm², and 2 mA/cm². As shown, the new separator created according to the teachings herein exhibited better stability up to 2 mA/cm² current density than the commercial separator, as evidenced by the flatter peaks using the new separator vs. the noisy peaks using the commercial separator.

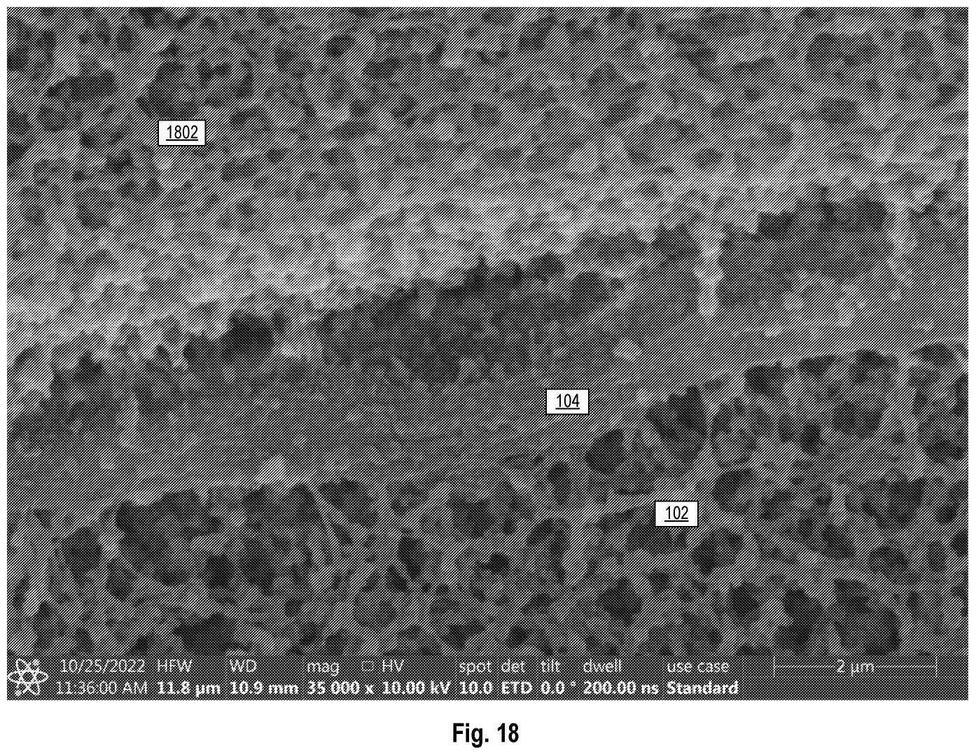

FIG. 18 is an SEM image of a trilayer structure having a skin layer 104 formed concurrently with an underlying first layer 102. A second first layer 1802 was later formed on the skin layer 104.

### In Use

Various embodiments disclosed herein may be used by battery manufacturers to assemble Li-ion batteries, lithium sulfur batteries, lithium air batteries, flow batteries, and fuel cells. Various embodiments may also be used for high efficiency separation processes including separation and purification of rare earth materials and for medical applications such as dialysis membranes.

In some approaches, a product as described herein is a separator, or portion thereof, for removing a target gas such as CO₂ from a source mixture such as flue gas, etc. having the target gas therein.

In some approaches, a product as described herein is a hemodialysis machine or portion thereof.

In some approaches, a product as described herein is a fuel cell or portion thereof.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A product, comprising:
a porous first layer having a first porosity; and
a porous skin layer having a second porosity that is relatively lower than the first porosity;
wherein the skin layer is a self-formed layer.

2. The product of claim 1, wherein the first and skin layers have physical characteristics of simultaneous formation via curing.

3. The product of claim 1, comprising a porous second layer above the skin layer, and a porous second skin layer above the second layer.

4. The product of claim 3, comprising a porous third layer above the second skin layer, and a porous third skin layer above the third layer.

5. The product of claim 1, wherein a thickness of the skin layer is less than about one quarter of a thickness of the first layer.

6. The product of claim 1, wherein a thickness of the skin layer is less than about one tenth of a thickness of the first layer.

7. The product of claim 1, wherein pores of the first and skin layers have physical characteristics of a previously-present porogen.

8. The product of claim 1, wherein the first porosity is in a range of about 40% to about 90% by volume of the total peripheral volume of the first layer.

9. The product of claim 1, wherein an average pore size of the skin layer is less than about 2 micrometers.

10. The product of claim 1, wherein the second porosity is sufficient to prevent passage of lithium dendrites through the skin layer.

11. The product of claim 1, wherein the skin layer is configured to substantially prevent passage of polysulfide anions through the skin layer.

12. The product of claim 1, comprising a cathode on one side of the layers and an anode on an opposite side of the layers.

13. The product of claim 12, wherein the cathode and/or the anode have three-dimensional features extending away from the layers in a direction about perpendicular to a plane of the layers.

14. The product of claim 1, wherein the product is a battery, wherein the layers act as a separator of the battery.

15. The product of claim 1, wherein the product is a separator, or portion thereof, for removing a target gas from a source mixture having the target gas therein.

16. The product of claim 1, wherein the product is a hemodialysis machine or portion thereof.

17. The product of claim 1, wherein the product is a fuel cell or portion thereof.

18. A method, comprising:
contacting a resin with a separator; and
exposing the resin to radiation for curing the resin, thereby simultaneously creating a porous first layer and a porous skin layer positioned between the first layer and the separator,
wherein the first layer has a first porosity,
wherein the skin layer has a second porosity that is relatively lower than the first porosity.

19. The method of claim 18, wherein the resin includes at least one monomer, and a material selected from the group consisting of: a solvent that acts as a porogen, a porogen, and a solvent and a porogen.

20. The method of claim 18, wherein the separator includes a material selected from the group consisting of: fluorinated ethylene propylene, polytetrafluoroethylene (PTFE), silicone, glass, polypropylene, and polyethylene.

21. The method of claim 18, comprising creating a relative movement between a stage upon which the layers are formed and the separator; adding unexposed resin above the layers; contacting the unexposed resin with the separator; and exposing the unexposed resin to radiation for simultaneously creating a porous second layer and a porous second skin layer positioned between the second layer and the separator.
